(19) United States
(12) Patent Application Publication
(10) Pub. No.: US 2022/0167026 A1
(43) Pub. Date: May 26, 2022

(54) NETWORK BASED MEDIA PROCESSING CONTROL

(71) Applicant: Nokia Technologies Oy, Espoo (FI)

(72) Inventors: Yu YOU, Kangasala (FI); Sujeet Shyamsundar MATE, Tampere (FI); Kashyap KAMMACHI SREEDHAR, Tampere (FI); Wolfgang VAN RAEMDONCK, Antwerp (BE)

(21) Appl. No.: 17/440,408

(22) PCT Filed: Mar. 21, 2019
(86) PCT No.: PCT/FI2019/050236

§ 371 Date: Sep. 17, 2021

(51) Int. Cl. H04N 21/235; H04N 21/2343; H04N 21/6543; G06N 7/00

(52) U.S. Cl. CPC H04N 21/2353; H04N 21/2355; G06N 7/005; H04N 21/6543; H04N 21/2343

(57) ABSTRACT

According to an example aspect of the present invention, there is provided a method, comprising: receiving, by a workflow manager from a source entity, a workflow description for network based media processing, the workflow description comprising a workflow task optimization information element, generating a workflow on the basis of the workflow description, the workflow comprising a set of connected media processing tasks, and causing workflow task modification to optimize the workflow on the basis of one or more parameters in the optimization information element.

### FIELD

Various example embodiments relate to network based media processing, and in particular dynamic workflow control management thereof.

### BACKGROUND

Network based media processing, NBMP, allows service providers and end users to distribute media processing operations. NBMP provides a framework for distributed media and metadata processing, which may be performed in IT and telecom cloud networks.

NBMP abstracts the underlying compute platform interactions to establish, load, instantiate and monitor the media processing entities that will run the media processing tasks. An NBMP system may perform: uploading of media data to the network for processing; instantiating media processing entities (MPE)s; configuring the MPEs for dynamic creation of media processing pipeline; and accessing the processed media data and the resulting metadata in a scalable fashion in real-time or in a deferred way. The MPEs may be controlled and operated by a workflow manager in a NBMP platform that comprises computation resources for implementing the workflow manager and the MPEs.

### SUMMARY

Some aspects of the invention are defined by the features of the independent claims. Some specific embodiments are defined in the dependent claims.

According to a first example aspect, there is provided a method, comprising: receiving, by a workflow manager from a source entity, a workflow description for network based media processing, the workflow description comprising a workflow task optimization information element, generating a workflow on the basis of the workflow description, the workflow comprising a set of connected media processing tasks, and causing workflow task modification to optimize the workflow on the basis of one or more parameters in the optimization information element.

According to a second example aspect, there is provided a method, comprising: generating a workflow description for network-based media processing, including in the workflow description a workflow task optimization information element that defines one or more parameters to perform workflow task modification to optimize a workflow generated on the basis of the workflow description, and causing transmitting the workflow description comprising the workflow task optimization information element to a workflow manager.

There is also provided an apparatus comprising at least one processor, at least one memory including computer program code, the at least one memory and the computer program code being configured to, with the at least one processor, cause the apparatus at least to carry out features in accordance with the first and/or second aspect, or any embodiment thereof.

According to still further example aspects, there are provided a computer program and a computer-readable medium, or a non-transitory computer-readable medium, configured, when executed in a data processing apparatus, to carry out features in accordance with the first and/or second aspect, or an embodiment thereof.

### BRIEF DESCRIPTION OF THE DRAWINGS

Some example embodiments will now be described with reference to the accompanying drawings.

FIG. 1 illustrates an example of NBMP system;

FIGS. 2 to 4 are flow graphs of methods in accordance with at least some embodiments;

FIG. 5 illustrates workflow and resulting task deployment,

FIG. 6 illustrates an example of a media processing workflow and task placement;

FIG. 7 illustrates task enhancement;

FIG. 8 illustrates task fusion; and

FIG. 9 illustrates an example apparatus capable of supporting at least some embodiments.

### EMBODIMENTS

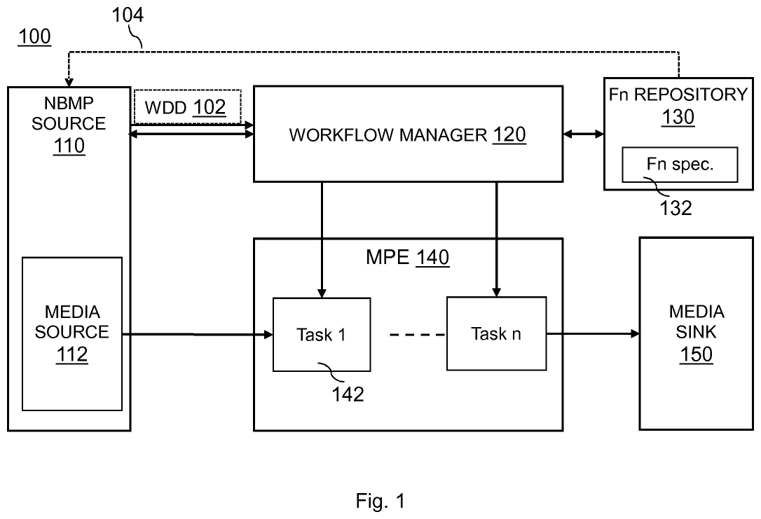

FIG. 1 illustrates a Network-based Media Processing (NBMP) system 100, which is a system for processing that is performed across processing entities in the network.

The system 100 comprises an NBMP source 110, which is an entity that provides media content to be processed. The NBMP source triggers and describes media processing for the NBMP system by a workflow description. The NBMP source describes the requested media processing and provides information about the nature and format of the associated media data in the workflow description. The NBMP source may comprise or be connected to one or more media sources 112, such as a video camera, an encoder, or a persistent storage. The NBMP source 110 may be controlled by a third-party entity, such as a user equipment or another type of entity or device providing feedback, metadata, or network metrics to the NBMP source 110, for example.

A workflow manager 120 is an entity that orchestrates the network-based media processing and may also be referred to as a (NBMP) control function. The workflow manager receives the workflow description from the NBMP source via a workflow API and builds a workflow for requested media processing. The workflow description, which may also be herewith referred to as the workflow description document (WDD), describes the information that enables the NBMP workflow. The workflow manager 120 provisions tasks and connects them to create a complete workflow based on the workflow description document and function descriptions. The NBMP workflow provides a chain of one or more task(s) to achieve a specific media processing. Chaining of task(s) can be sequential, parallel, or both at any level of the workflow. The workflow may be represented as a directed acyclic graph (DAG).

The workflow manager 120 can be implemented with a dedicated server that may be virtualized, but also as a function in cloud computing. Hence, instead of a processor and memory, the workflow manager 120 may comprise a processing function and a memory function for processing and storing data. On top of these functions, the workflow manager 120 may also comprise some further functions such as a persistent storing function and a communication interface function alike various other entities herein, but such functions are not illustrated in sake of brevity and simplicity.

The system 100 further comprises a function repository 130. In an example embodiment, the function repository 130 is a network based function. In an example embodiment, the function repository 130 stores a plurality of function specifications 132 for use by the workflow manager 120 in defining tasks to a media processing entity 140. A function discovery API to the function repository 130 enables the workflow manager and/or the NBMP source (by 104) to discover media processing functions that can be loaded as part of a media processing workflow.

A Media Processing Entity (MPE) is an entity performing one or more media processing tasks provisioned by the workflow manager 120. The MPE executes the tasks applied on media data and related metadata received from the NBMP source 110 via an NBMP task API or another MPE. The task(s) in the MPE produce media data and related metadata to be consumed by a media sink entity 150 or other task(s) in another MPE. The media sink entity 150 is generally a consumer of the output of a task of a MPE. The content processed by the task 142 may be sent in a NBMP publish format to the media sink entity through existing delivery methods with suitable media formats, for example through download, DASH, MMT, or other means.

A network based media processing (or NBMP) function may be a standalone and self-contained media processing operation and the corresponding description of that operation. The NBMP function performs processing of the input media that can generate output media or metadata. Non-limiting examples of such media processing include; content encoding, decoding, content encryption, content conversion to HDR, content trans-multiplexing of the container format, streaming manifest generation, frame-rate or aspect ratio conversion, and content stitching, etc. A media processing task (also referred to as “task” for brevity below) is a running instance of a network based media processing function that gets executed by the MPE 140.

In an example embodiment, the MPE 140 is a process or execution context (e.g. appropriate hardware acceleration) in a computer. Multiple MPEs may be defined also in a single computer. In this case, communications between tasks across MPEs can happen through process-friendly protocols such as Inter-Process Communication (IPC).

In an example embodiment, the MPE 140 is a dedicated apparatus, such as a server computer. In another example embodiment, the MPE 140 is a function established for this purpose by the workflow manager 120 using, for example, a suitable virtualization platform or cloud computing. In these cases, communications between tasks is carried out across MPEs which typically use IP-based protocols.

The workflow manager 120 has a communicative connection with the NBMP source 110 and with the function repository 130. In an example embodiment, the function repository 130 further has a communicative connection with the NBMP source 110. The workflow manager 120 communicates with the underlying infrastructure (e.g. a cloud orchestrator) to provision the execution environments such as containers, virtual machines (VMs), or physical computer hosts, which may thus operate as MPEs.

The NBMP system 100 may further comprise one or more stream bridges, optionally interfacing the media processing entity 140 with the media source 112 and a media sink 150, respectively.

Since the workflows and associated DAGs may become very complex, it is important to have a well-established control and granularity level to define how and where to deploy media processing tasks, that is, the correlation between the media processing tasks and MPEs, and between the processing tasks. There are now provided improvements for guiding or controlling network based media processing workflow generation. More fine-grained policies are now defined for guiding the workflow generation and optimization, which may be included in the WDD as new information elements (IEs) and parameters.

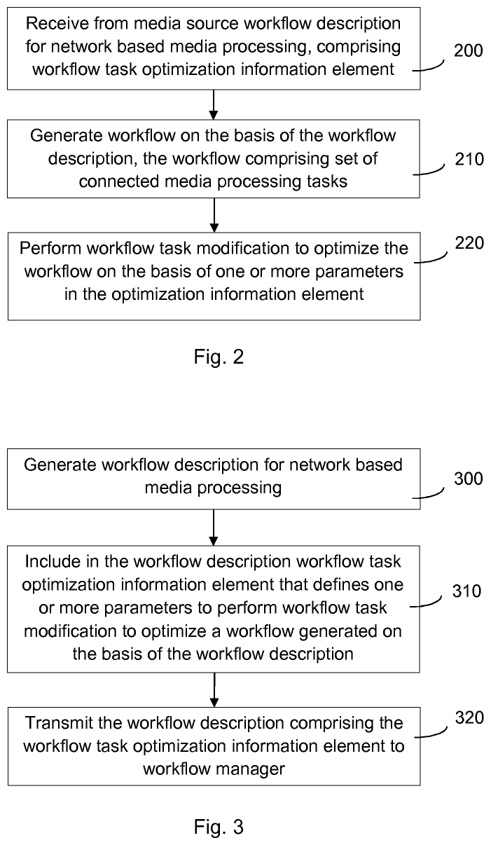

FIG. 2 illustrates a method for controlling network based media processing workflow generation and optimization thereof. The method may be implemented by an apparatus generating or controlling media processing workflows, such as the workflow manager 120.

A workflow description for network based media processing is received 200 from a source entity, such as the NBMP source entity 110. The workflow description comprises a workflow task optimization information element. The workflow task optimization information element may define one or more policies defining how the workflow may be optimized, before (or in some embodiments after) deployment to media processing entities. It is to be appreciated that the workflow task optimization information element may comprise one or more parameters, and may comprise one or more fields included in the workflow description.

A workflow is generated 210 on the basis of the workflow description, the workflow comprising a set of connected media processing tasks. For example, the workflow may be a NBMP workflow DAG generated based on the WDD.

A workflow task modification is performed 220 to optimize the workflow on the basis of one or more parameters in the optimization information element. In some embodiments, task fusion, task enhancement, and/or task grouping is applied for at least some of the tasks.

In some embodiments, block 220 is entered in response to detecting the workflow task optimization information element in the received workflow description. In an example embodiment, the workflow task optimization information element is checked, and if one or more workflow task optimization/modification (sub-)procedures are enabled by the information element, the respective (sub-)procedures are initiated.

The workflow manager may then, on the basis of the workflow after the workflow task modification, deploy media processing tasks by a set of selected MPEs.

FIG. 3 illustrates a method for controlling network based media processing workflow generation and optimization thereof. The method may be implemented in an apparatus initiating generation of media processing workflows, such as the NBMP source entity 110 providing the workflow description to the workflow manager 120 performing the method of FIG. 2.

A workflow description is generated 300 for network-based media processing. A workflow task optimization information element is included 310 in the workflow description. The workflow task optimization information element defines one or more parameters to perform a workflow task modification to optimize a workflow generated on the basis of the workflow description. The workflow description comprising the workflow task optimization information element is sent 320 from a source entity to a workflow manager.

Before block 300, the NBMP source 110 may connect the function repository 130 and receive function specification data from the function repository. The workflow description may be defined, or generated in block 300, based on the received function specification data.

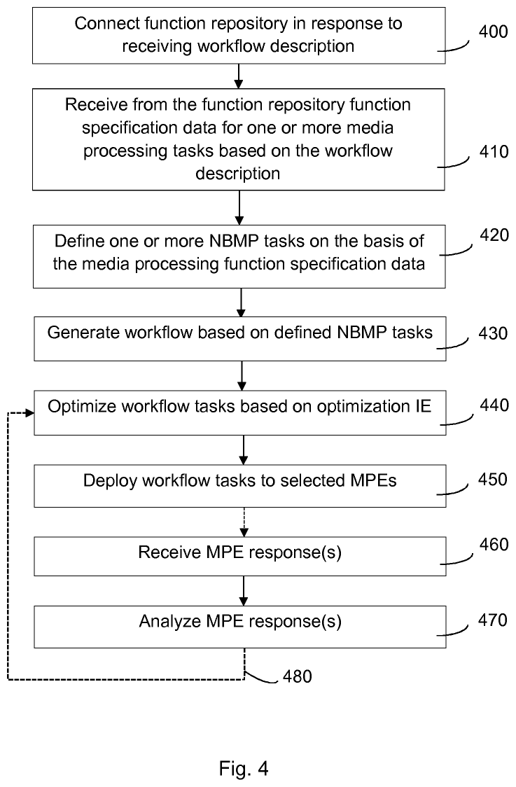

FIG. 4 illustrates further features for the apparatus configured to perform the method of FIG. 2, such as the workflow manager 120.

When a request for media processing, and the workflow description, is received from the NBMP source 110, the workflow manager 120 connects 400 the function repository 130. The workflow manager may thus scan function repository to find the list of all functions that could fulfill the request. In block 410 function specification data is received for one or more media processing tasks based on the workflow description.

NBMP tasks are defined 420 on the basis of the received media processing function specification data (and the workflow description). Using the workflow description from the NBMP source 110, the workflow manager 120 may thus check to detect which functions from the function repository need to be selected for meeting the workflow description. This checking may depend on the information for media processing from the

NBMP source, such as input and output description, description of the requested media processing; and different descriptors for each function in the function directory. The request(s) are mapped to appropriate media processing tasks to be included in the workflow. Once the functions required to be included in the workflow are identified using the function repository, the next step is to run them as tasks and configure those tasks so they can be added to the workflow.

Once the required tasks are defined (e.g. as a task list), the workflow DAG may be generated 430 on the basis of the defined tasks. Workflow task optimization is performed in block 440 on the basis of the optimization IE. Tasks of the (optimized) workflow may be deployed 450 to selected MPEs.

The workflow manager 120 may thus calculate the resources needed for the tasks and then apply for selected MPE(s) 140 from infrastructure provider(s) in block 450. The number of assigned MPEs and their capabilities may be based upon the total estimated resource requirement of the workflow and the tasks, with some over-provisioning capabilities in practice. The actual placement may be carried out by a cloud orchestrator, which may reside in a cloud system platform.

Using the workflow information, the workflow manager may extract the configuration data and configure the selected tasks once the workflow is final. The configuration of these tasks may be performed using the Task API supported by those tasks. The NBMP source entity 110 may further be informed that the workflow is ready and that media processing can start. The NBMP source(s) 110 can then start transmitting their media to the network for processing.

In some embodiments, the NBMP workflow manager 120 may generate an MPE application table that comprises minimal and maximal MPE requirements per task and sends the table (or part thereof) to the cloud infrastructure/orchestrator for MPE allocation.

In some embodiments, as further illustrated in FIG. 4, response(s) may be received 460 from one or more of the MPE(s) regarding their deployed task(s). The response may comprise information regarding the deployment of task(s). In an example embodiment, the response comprises response parameters for a create task request of the task configuration API.

The workflow manager 120 may then analyze 470 the MPE response(s), e.g. evaluate the MPE and its capability to fulfill the task(s) appropriately. If necessary, the workflow manager may cause 480 workflow task re-modification on the basis of the evaluation of the media processing entities and the optimization IE.

Upon the response(s) 460, the workflow manager 120 can re-optimize 480 the workflow and may result in a different workflow DAG. The process can be repeated until the workflow manager detects the workflow as optimal or acceptable.

Instead of recursive workflow generation and optimization, it is possible to apply parallel workflow generation and optimization, wherein at least some of the blocks 430 to 470 may be carried out for a plurality of workflow candidates. Finally, one of the candidates is selected by the workflow manager for final deployment.

The workflow generated 430 and optimized 440 by the workflow manager 120 can be represented using a DAG. Each node of the DAG represents a processing task in the workflow. The links connecting one node to the other node in the graph represents the transfer of output of the former as input to the later. Details for input and output ports for a task may be provided in a general descriptor of a task.

A task connection map parameter may be applied to describe DAG edges statically and is a read/write property. The task connection map may provide placeholder and indicate parameters for the task optimization IEs. Further, there may a list of task identifiers, which may be referred to as a task set. The task set may define task instances and their relationship with NBMP functions, and comprise references to task descriptor resources, managed via the Workflow API.

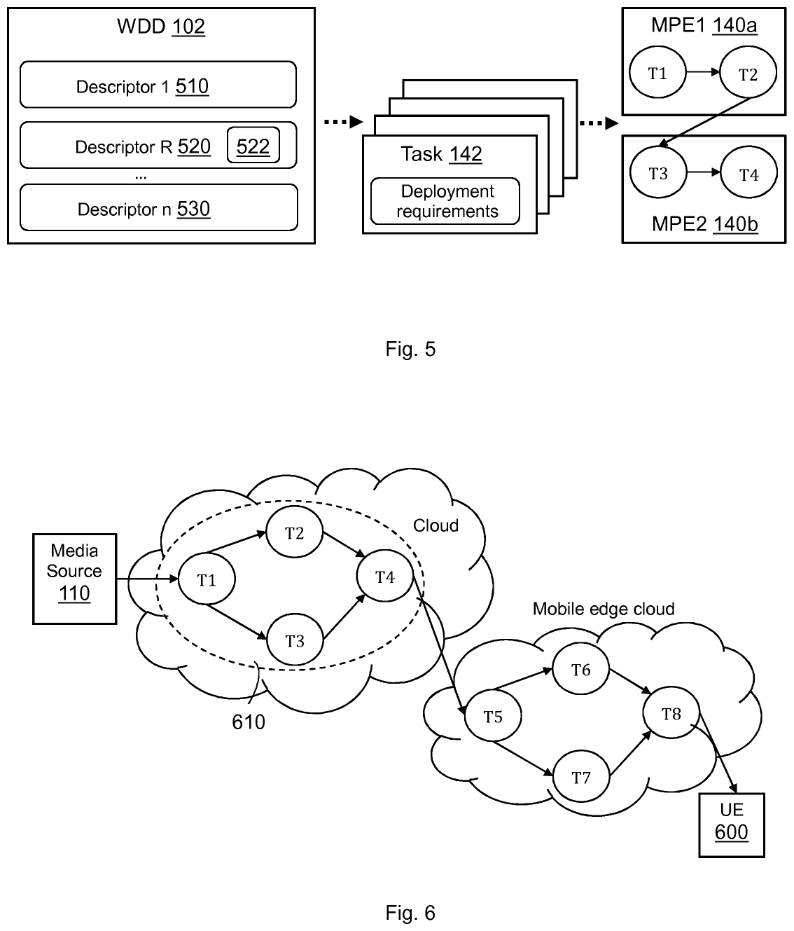

FIG. 5 illustrates a WDD 102. The WDD may be a container file or a manifest with key data structures comprising multiple descriptors 510, 520, 530 from functional ones (e.g. input/output/processing) to non-functional ones (e.g. requirements). The WDD 102 describes details such as input and output data, required functions, requirements etc. for the workflow by the set of descriptors 510, 520, 530. For example, the WDD may comprise at least some of a general descriptor, an input descriptor, an output descriptor, a processing descriptor, a requirement(s) descriptor 520, a client assistance descriptor, a failover descriptor, a monitoring descriptor, an assertion descriptor, a reporting descriptor, and a notification descriptor.

The optimization information element may be an independent descriptor or combined with or included in another descriptor. In some embodiments, the optimization information element is included as part 522 of the requirements descriptor 520 of the WDD 102. The workflow optimization information element may be included as part of processing and/or deployment requirements of the WDD 102 or the requirements descriptor 520 thereof. The workflow description and the workflow task optimization information element may be encoded in JavaScript Object Notation (JSON) or Extensible Markup Language (XML), for example.

FIG. 5 also illustrates that individual NBMP tasks 142 are generated on the basis of the WDD 102. NBMP tasks 142 are instances of the NBMP function templates (from the function repository 130), which may reuse and share same syntax and semantics from some of the descriptors applied also in the WDD.

On the basis of the requirements descriptor 520, such as deployment requirements of each task, one or more MPE(s) may be selected and a workflow DAG involving one or more MPEs 140 may be generated. In the simple example of FIG. 5, tasks T1 and T2 are deployed by a first MPE1 140a, and subsequent tasks T3 and T4 by a second MPE2 140b.

FIG. 6 provides another example, illustrating a media processing workflow comprising tasks T1-T8 from NBMP source 110 to a user equipment (which may the media sink) 600. Some of the tasks have been allocated to a (central) cloud system, whereas other tasks are carried out by a mobile edge computing cloud system.

In some embodiments, the workflow task optimization information element defines if NBMP system tasks may be added and/or removed to/from the workflow. Task placement may be optimized by the workflow manager based on requirements of the workflow optimization information element. The workflow task modification 220 may comprise dynamically adding and/or removing some supportive tasks, such as buffering and media content transcoding tasks, when needed, between two assigned tasks by the WDD 102. When such tasks are planned to be deployed in different MPEs running in different hosts, the workflow manager 120 may need to determine and re-configure the workflow graph with reconfigured task connectors. The workflow manager may further need to determine and configure proper socket-based networking components by appropriate task creation API to the MPEs, for example.

In an embodiment, policies can be represented in the workflow optimization information element as a key-value structure or tree with nested hierarchical nodes when needed. In an embodiment, the hierarchy of the NBMP workflow and tasks can reflect the similar structure of the deployment requirements. That is, the requirements at the workflow level may be applicable to all tasks of the workflow. The requirements of individual tasks can override workflow-level requirements, when conflicting requirements occur.

In some embodiments, the workflow task optimization information element is indicative of media processing task enhancement, or task enhancement policy. Task enhancement may be performed in block 220 and 440, and may comprise modifying and/or adding one or more tasks as a result of a task enhancement analysis to optimize the workflow. The task enhancement analysis may comprise evaluating if one or more task enhancement actions need to be performed for one or more tasks of the workflow, and may further comprise defining required task enhancement actions and further control information for them. The task enhancement information element may indicate if and input and/or output of a workflow or task can be modified or enhanced with system-provided built-in tasks, such as media transcoding, media transport buffering for synchronization, or transporting tasks for streaming data over different networks.

For example, task enhancement may comprise one or more of re-configuration of an input port of a task, re-configuration of an output port of a task, and re-configuration of a protocol of a task. Such reconfiguration may require injection of additional task(s) to the workflow.

The task enhancement information in the workflow task optimization IE may indicate if enhancement of tasks is enabled or not, and/or further parameters for task enhancement. In one example embodiment, the task enhancement information is included as the IE 522 in the requirements descriptor 520, such as in processing requirements of the requirements descriptor, e.g. as task or workflow requirements. The workflow manager 120 may be configured to analyze (an initial) workflow to detect task enhancement opportunities in response to detecting based on the task enhancement IE that task enhancement is allowed.

The task enhancement may represent a reversed approach to task fusion. The workflow manager may be configured to place tasks in different/dedicated MPEs for guaranteed quality of service, for example, with dedicated hardware accelerated environments for AI/machine learning tasks.

In some embodiments, the task enhancement may comprise or enable at least some of the following new features and tasks added by the workflow manager 120:
Automatic network streaming sender and receiver tasks: The connection may be configured by the workflow manager after final task placement is confirmed by a cloud provider and MPE information is communicated back from the cloud infrastructure to the workflow manager;
Automatic media content encoding and decoding, which may be needed when the data transport between two tasks in one MPE is changed from local to network-based. Typically, the media data should also be compressed instead of raw bitstreams. Such encoding and decoding formats (e.g. H264 AVC or H265 HEVC) can be determined by the workflow manager automatically in a transparent way. Alternatively, the use of specific compression or encryption methods can be provided in the WDD.

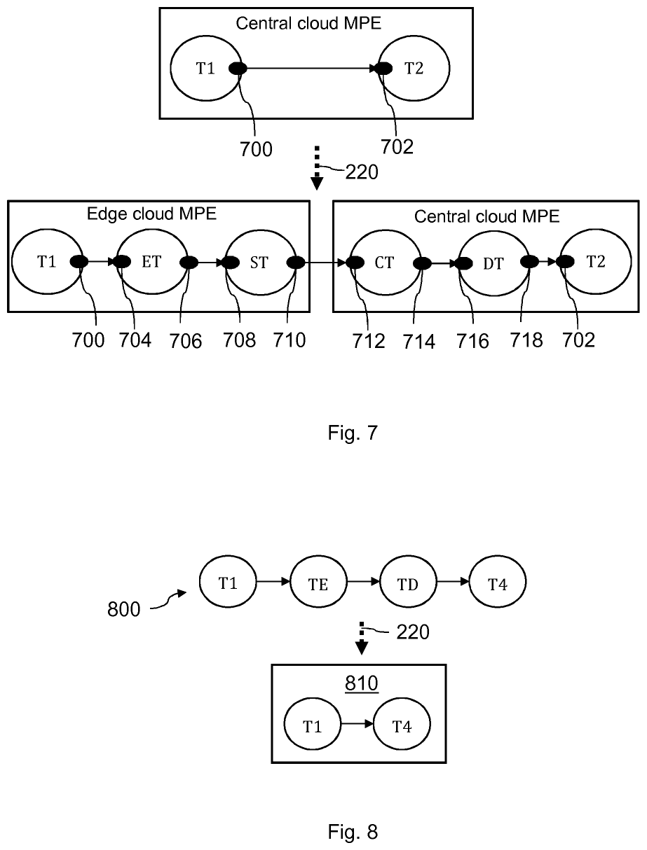

FIG. 7 illustrates task enhancement for an initial simplified example workflow 700. The initial workflow comprises a task Ti with output port 700 and task T2 with input port 702, which may be assigned to a central cloud system, for example. On the basis of the workflow task optimization IE, the workflow manager 120 detects that task enhancement is enabled. Based on task enhancement analysis of the initial workflow, the workflow manager 120 detects that task Ti should be instead carried out by an edge cloud.

After workflow task modification 220, the resulting workflow is substantially different; it comprises a first portion carried by an edge cloud MPE and a second portion carried out by the central cloud MPE. In order to enable this, a new encoding task ET and a new decoding task DT are added, with respective input ports 704, 716 and output ports 706, 718. For example, the ET may comprise a H.265 encoder and payloader task and the DT unpacker and H.265 decoder task. Further, appropriate transmission task(s) may need to be added. For example, new transport layer server (e.g. TCP server sink) task ST and transport layer client (e.g. TCP client) task CT are added, with respective input ports 708, 712 and output ports 710, 714.

In some embodiments, the task enhancement may comprise task splitting, which may refer to dividing an initial task to two or more tasks. Alternatively, task splitting is an independent optimization method, and may be included as a specific IE in the WDD 102, similarly as illustrated above for the task enhancement information, for example.

In some embodiments, the workflow task optimization IE is indicative of media processing task fusion, or task fusion policy. Task fusion may be performed in block 220 and 440 and may comprise removing and/or combining one or more tasks as a result of a task fusion analysis to optimize the workflow. The task fusion analysis may comprise evaluating if one or more task fusion actions need to be performed for one or more tasks of the workflow, and may further comprise defining required task fusion actions and further control information for them. Task fusion information in the workflow task optimization IE may indicate if fusing of tasks is enabled or not, and/or further parameters for the task fusion. In one example embodiment, the task fusion information is included as the IE 522 in the requirements descriptor 520, such as in processing requirements of the requirements descriptor, e.g. as task or workflow requirements. The workflow manager 120 may be configured to analyze (an initial) workflow to detect task fusion opportunities in response to detecting based on the task optimization IE that task fusion is allowed. Task fusion enables to remove unnecessary media transcoding and/or network transporting tasks to gain better performance, e.g., decrease latency and better bandwidth and throughputs.

FIG. 8 illustrates task fusion for an initial simplified example workflow 800.

The initial workflow comprises a task TE involving encoding of a media stream and a subsequent task TD involving decoding of the media stream. For example, the tasks TE and TD may involve H264 encoding and decoding, and may be defined to be performed in different MPEs. On the basis of the workflow task optimization IE, the workflow manager 120 detects that task fusion is enabled. Based on task fusion analysis of the initial workflow 800, the workflow manager 120 detects that tasks TE and TD are superfluous and may be removed. The workflow is accordingly updated as a result of the workflow task modification 220, and the resulting workflow 810 may be deployed.

Task fusion may be carried out on dedicated MPEs, such as hardware accelerated ones (e.g. GPU-powered MPEs for fast media processing or AI/ML training and inferencing tasks). Those special MPEs are usually stationary and pre-provisioned. Another approach is that the media processing function is made up with a group of functions, a concept which may be referred to as “Function group”. A function group may be constructed as a partial or sub-DAG. The workflow manager can go through all functions defined for a function group and decide the final workflow DAG. Task fusion may be carried out on the basis of low level processing tasks, which may be defined to have more fine-grained deployment control. High-level media processing tasks may be more difficult to be fused, but may still be possible, as long as relevant operation logic can be re-defined by other low-level processing tasks.

In some embodiments, the WDD 102 comprises media processing task grouping information. On the basis of the task grouping information, the workflow manager 120 may group two or more tasks of the workflow together. For example, in FIG. 6 the tasks T1 to T4 may be grouped 610 on the basis of the task grouping information and controlled to be deployed in a single MPE. The task grouping information may indicate if grouping of tasks is enabled or not, and/or further parameters for task grouping, such as logic group name(s). In one example embodiment, the task grouping information is included in the requirements descriptor 520, such as in processing requirements of the requirements descriptor, e.g. as deployment requirements.

In some embodiments, the WDD 102 comprises location policy information for controlling placement of one or more media processing tasks of the workflow. The location policy information may comprise at least one of the following sets of locations for each of the one or more media processing tasks: prohibited locations, allowed locations, and/or preferred locations. Thus, for example, allocation of media processing tasks to certain countries or networks may be avoided or ensured. The location policy information may comprise media-source defined location preference, such as geographic data center(s) or logic location(s). In one example embodiment, the location policy information is included in the requirements descriptor 520, such as in processing requirements of the requirements descriptor, e.g. as deployment requirements.

In some embodiments, the workflow description comprises task affinity and/or anti-affinity information indicative of placement preference relative to media processing tasks and/or media processing entities.

The task affinity information may indicate placement preference relative to the associated tasks. The task anti-affinity information may indicate placement preference relative to those tasks which should not be together in the same MPE. For example, two computing hungry tasks should not be scheduled and run in the same MPE. In another example, the affinity information may specify that tasks from different workflows must not be sharing one MPE, etc.

In an embodiment, the workflow description comprises MPE affinity and/or anti-affinity information, which may specify (anti-)affinity controls to MPEs (instead of tasks).

In one example embodiment, the affinity and/or anti-affinity information is included in the requirements descriptor 520, such as in processing requirements of the requirements descriptor, e.g. as deployment requirements.

Annex 1 is an example chart of information elements and associated parameters, comprising Task/Workflow Requirements, Deployment Requirements, and also QoS Requirements. For example, the Task/Workflow Requirements and/or Deployment

Requirements may be included in Processing Requirements of a Requirements descriptor of the WDD 102. It is to be appreciated that at least some of the parameters illustrated in Annex 1 may be applied in the workflow description by applying at least some of the embodiments illustrated above.

It is to be appreciated that above embodiments illustrate only some examples of available options for incorporating the workflow requirements and workflow optimization information element in NBMP signaling and the WDD 102, and various other placement and naming options can be used.

An electronic device comprising electronic circuitries may be an apparatus for realizing at least some embodiments of the present invention. The apparatus may be or may be comprised in a computer, a network server, a cellular phone, a machine to machine (M2M) device (e.g. an IoT sensor device), or any other network or computing apparatus provided with communication capability. In another embodiment, the apparatus carrying out the above-described functionalities is comprised in such a device, e.g. the apparatus may comprise a circuitry, such as a chip, a chipset, a microcontroller, or a combination of such circuitries in any one of the above-described devices.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

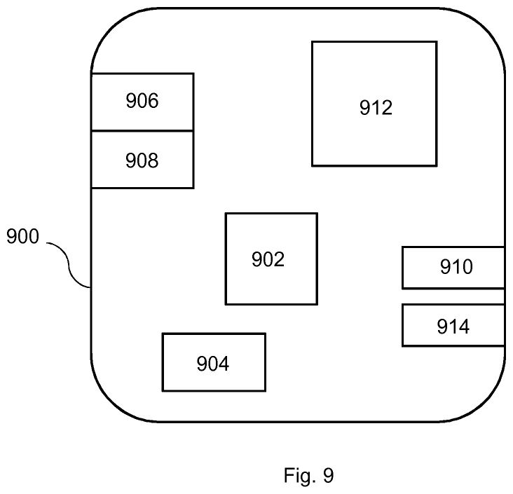

FIG. 9 illustrates an example apparatus capable of supporting at least some embodiments of the present invention. Illustrated is a device 900, which may comprise a communication device configured to control network based media processing. The device may include one or more controllers configured to carry out operations in accordance with at least some of the embodiments illustrated above, such as some or more of the features illustrated above in connection with FIGS. 2 to 8. For example, the device 900 device may be configured to operate as the workflow manager or the NBMP source performing the method of Figure.

Comprised in the device 900 is a processor 902, which may comprise, for example, a single- or multi-core processor wherein a single-core processor comprises one processing core and a multi-core processor comprises more than one processing core. The processor 902 may comprise more than one processor. The processor may comprise at least one application-specific integrated circuit, ASIC. The processor may comprise at least one field-programmable gate array, FPGA. The processor may be means for performing method steps in the device. The processor may be configured, at least in part by computer instructions, to perform actions.

The device 900 may comprise memory 904. The memory may comprise random-access memory and/or permanent memory. The memory may comprise at least one RAM chip. The memory may comprise solid-state, magnetic, optical and/or holographic memory, for example. The memory may be at least in part comprised in the processor 902. The memory 904 may be means for storing information. The memory may comprise computer instructions that the processor is configured to execute. When computer instructions configured to cause the processor to perform certain actions are stored in the memory, and the device in overall is configured to run under the direction of the processor using computer instructions from the memory, the processor and/or its at least one processing core may be considered to be configured to perform said certain actions. The memory may be at least in part comprised in the processor. The memory may be at least in part external to the device 900 but accessible to the device. For example, control parameters affecting operations related to network based media processing workflow control may be stored in one or more portions of the memory and used to control operation of the apparatus. Further, the memory may comprise device-specific cryptographic information, such as secret and public key of the device 900.

The device 900 may comprise a transmitter 906. The device may comprise a receiver 908. The transmitter and the receiver may be configured to transmit and receive, respectively, information in accordance with at least one cellular or non-cellular standard. The transmitter may comprise more than one transmitter. The receiver may comprise more than one receiver. The transmitter and/or receiver may be configured to operate in accordance with global system for mobile communication, GSM, wideband code division multiple access, WCDMA, long term evolution, LTE, 3GPP new radio access technology (N-RAT), IS-95, wireless local area network, WLAN, and/or Ethernet standards, for example. The device 900 may comprise a near-field communication, NFC, transceiver 910. The NFC transceiver may support at least one NFC technology, such as NFC, Bluetooth, Wibree or similar technologies.

The device 900 may comprise user interface, UI, 912. The UI may comprise at least one of a display, a keyboard, a touchscreen, a vibrator arranged to signal to a user by causing the device to vibrate, a speaker and a microphone. A user may be able to operate the device via the UI, for example to accept incoming telephone calls, to originate telephone calls or video calls, to browse the Internet, cause and control media processing operations, and/to manage digital files stored in the memory 904 or on a cloud accessible via the transmitter 906 and the receiver 908, or via the NFC transceiver 910.

The device 900 may comprise or be arranged to accept a user identity module 914. The user identity module may comprise, for example, a subscriber identity module, SIM, card installable in the device 900. The user identity module 914 may comprise information identifying a subscription of a user of device 900. The user identity module 914 may comprise cryptographic information usable to verify the identity of a user of device 900 and/or to facilitate encryption of communicated media and/or metadata information for communication effected via the device 900.

The processor 902 may be furnished with a transmitter arranged to output information from the processor, via electrical leads internal to the device 900, to other devices comprised in the device. Such a transmitter may comprise a serial bus transmitter arranged to, for example, output information via at least one electrical lead to memory 904 for storage therein. Alternatively to a serial bus, the transmitter may comprise a parallel bus transmitter. Likewise the processor may comprise a receiver arranged to receive information in the processor, via electrical leads internal to the device 900, from other devices comprised in the device 900. Such a receiver may comprise a serial bus receiver arranged to, for example, receive information via at least one electrical lead from the receiver 908 for processing in the processor. Alternatively to a serial bus, the receiver may comprise a parallel bus receiver.

The device 900 may comprise further devices not illustrated in FIG. 9. For example, the device may comprise at least one digital camera. Some devices 900 may comprise a back-facing camera and a front-facing camera. The device may comprise a fingerprint sensor arranged to authenticate, at least in part, a user of the device. In some embodiments, the device lacks at least one device described above. For example, some devices may lack the NFC transceiver 910 and/or the user identity module 914.

The processor 902, the memory 904, the transmitter 906, the receiver 908, the NFC transceiver 910, the UI 912 and/or the user identity module 914 may be interconnected by electrical leads internal to the device 900 in a multitude of different ways. For example, each of the aforementioned devices may be separately connected to a master bus internal to the device, to allow for the devices to exchange information. However, as the skilled person will appreciate, this is only one example and depending on the embodiment various ways of interconnecting at least two of the aforementioned devices may be selected without departing from the scope of the present invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

Annex 1:

| Category | Parameter Name | Parameter | Description |
|---|---|---|---|
| Task/ | function_fusible | Boolean | Whether or not functions can |
| Workflow | | | be grouped, enhanced, and |
| requirements | | | fused by NBMP Workflow |
| | | | Manager. When fused or |
| | | | enhanced, some system tasks |
| | | | may be added or dropped |
| | | | automatically and |
| | | | dynamically. |
| | function_I/O_enhanecable | Boolean | Whether or not the |
| | | | media/metadata input and |
| | | | output of a workflow or task |
| | | | can be modified or enhanced |
| | | | with system-provided built-in |
| | | | functions such as media |
| | | | transcoding, media transport |
| | | | buffering for synchronization, |
| | | | or transporting tasks for |
| | | | streaming data over different |
| | | | networks |
| Deployment | location | Array of String | Media Source-defined location |
| requirements | | | preference, e.g. geographic |
| | | | data center or logic locations |
| | group | Array of String | Logic group name |
| | task_affinity | Array of Task | Task affinity control point. |
| | | properties (e.g. | Placement preference relative |
| | | names or | to those tasks. The array can |
| | | keywords) | be an ordered list to reflect the |
| | | | correlation ecoefficiencies. |
| | | | Tasks properties can be |
| | | | properties of NBMP Task |
| | | | (e.g. names, brands, etc.) |
| | task_anti-affinity | Array of Task | Placement preference relative |
| | | properties | to those tasks which should |
| | | | not be together in the same |
| | | | MPE. For example, two |
| | | | computing hungry tasks |
| | | | should not be scheduled and |
| | | | run in the same MPE. Or tasks |
| | | | from different workflows must |
| | | | not be sharing one MPE, etc. |
| | | | Tasks properties can be |
| | | | properties of NBMP Task |
| | | | (e.g. names, brands, etc.) |
| | mpe_affinity | Array of MPE | Like (anti-)affinity controls to |
| | | properties | tasks, but to MPEs. Note: |
| | | | current NBMP does not |
| | | | specify the MPE properties. |
| | | | Here we can assume the |
| | | | Property Structure of a MPE |
| | | | can be as simple as a |
| | | | dictionary with properties |
| | | | such as name, version, name, |
| | | | high-performance optimized |
| | | | category (computing, I/O, and |
| | | | memory) |
| | mpe_anti-affinity | Array of MPE | (Similar to above) |
| | | properties | |
| QoS | Bandwidth | Min/Max numbers | Total bandwidth requirement |
| Requirements | Latency | Min/Max numbers | Processing latency |
| | | | requirement |

1-39. (canceled)

40. An apparatus comprising at least one processor; and at least one memory including computer program code; the at least one memory and the computer program code configured to, with the at least one processor, cause the apparatus at least to perform:
receive from a source entity a workflow description for network based media processing, the workflow description comprising a workflow task optimization information element;
generate a workflow on the basis of the workflow description, the workflow comprising a set of connected media processing tasks; and
cause workflow task modification to optimize the workflow on the basis of one or more parameters in the optimization information element.

41. The apparatus of claim 40, further configured to perform instantiating, by a workflow manager on the basis of the workflow after the workflow task modification, media processing tasks by a set of media processing entities.

42. The apparatus of claim 41, further configured to perform:
select the media processing entities on the basis of the workflow after the workflow task modification; and
cause deployment of the media processing tasks for the selected media processing entities.

43. The apparatus of claim 42, further configured to perform:
receive one or more responses from one or more of the selected media processing entities;
evaluate the selected media processing entities on the basis of the responses; and
cause workflow task re-modification on the basis of the evaluation of the media processing entities and the workflow task optimization information element.

44. The apparatus of claim 40, further configured to perform:
connect to a function repository in response to receiving the workflow description;
receive from the function repository media processing function specification data for one or more of the media processing tasks based on the workflow description;
define one or more network-based media processing tasks on the basis of the media processing function specification data; and
generate the workflow, which is representable as a directed acyclic graph, on the basis of the defined media processing tasks.

45. The apparatus of claim 40, wherein the workflow task optimization information element is indicative of media processing task fusion.

46. The apparatus of claim 40, wherein the workflow task optimization information element is indicative of media processing task enhancement.

47. The apparatus of claim 40, wherein the workflow task optimization information element comprises parameters defining modification or enhancement of input and/or output of a media processing workflow or a media processing task.

48. The apparatus of claim 40, wherein the workflow task optimization information element defines if network based media processing system tasks may be added and/or removed to/from the workflow.

49. The apparatus of claim 48, wherein the task optimization information element is included in a requirements descriptor of the workflow description.

50. An apparatus comprising at least one processor; and at least one memory including computer program code; the at least one memory and the computer program code configured to, with the at least one processor, cause the apparatus at least to perform:
generate a workflow description for network-based media processing;
include in the workflow description a workflow task optimization information element that defines one or more parameters to perform workflow task modification to optimize a workflow generated on the basis of the workflow description; and
cause transmitting the workflow description comprising the workflow task optimization information element to a workflow manager.

51. The apparatus of claim 50, further configured to perform:
receive function specification data from a function repository; and
define the workflow description based on the received function specification data.

52. The apparatus of claim 50, wherein the workflow task optimization information element is indicative of media processing task fusion.

53. The apparatus of claim 50, wherein the workflow task optimization information element is indicative of media processing task enhancement.

54. The apparatus of claim 50, wherein the workflow task optimization information element comprises parameters defining modification or enhancement of input and/or output of a media processing workflow or a media processing task.

55. The apparatus of claim 50, wherein the workflow task optimization information element defines if network based media processing system tasks may be added and/or removed to/from the workflow.

56. apparatus of claim 50, wherein the optimization information element is included in a requirements descriptor of the workflow description.

57. The apparatus of claim 56, wherein the optimization information element is included as processing requirements of the requirements descriptor.

58. A method, comprising:
receiving, by a workflow manager from a source entity, a workflow description for network based media processing, the workflow description comprising a workflow task optimization information element;
generating a workflow on the basis of the workflow description, the workflow comprising a set of connected media processing tasks; and
causing workflow task modification to optimize the workflow on the basis of one or more parameters in the optimization information element.

59. A method, comprising:
generating a workflow description for network-based media processing;
including in the workflow description a workflow task optimization information element that defines one or more parameters to perform workflow task modification to optimize a workflow generated on the basis of the workflow description; and
causing transmitting the workflow description comprising the workflow task optimization information element to a workflow manager.
